(19) United States
(12) Patent Application Publication
(10) Pub. No.: US 2002/0186199 A1
(43) Pub. Date: Dec. 12, 2002

(54) Portable PC keyboard and mouse tray

(76) Inventors: David Discema, Toms River, NJ (US); Stephen M. Discema, Toms River, NJ (US)

Correspondence Address: David Discema, 96 Buckingham Dr., Tom River, NJ, 08753, US

(21) Appl. No.: 09/854,582

(22) Filed: May 11, 2001

(51) Int. Cl. G09G 5/00

(52) U.S. Cl. 345/156

(57) ABSTRACT

The Portable PC keyboard and mouse tray is the first portable workstation for the laptop or keyboard and mouse fitted with an attached filled bag. Placement on the lap allows for the adjustment of distance between the user and monitor, adjustment of the tilt of the laptop or keyboard for comfort and reduced strain of the wrist. Optimum placement of mouse reduces shoulder and back strain.

### CROSS REFERENCE TO RELATED APPLICATIONS

Not Applicable

### FEDERAL SPONSORED R & D

No Applicable

### REFERENCE TO SEQUENCE LISTING, A TABLE OR COMPUTER PROGRAM LISTING APPENDIX

No Applicable

### BACKGROUND OF INVENTION

This invention relates to the portable workstation designed to hold & secure a computer keyboard and mouse on the users lap for added comfort and posture improvement.

All computers are equipped with a needed keyboard and mouse. There is no properly positioned work area provided with this standard equipment. Therefore consumers were forced to place these items on a desk area. They must reach and or strain their shoulder and back muscles after extended periods of computer work due to the lack of a given workspace.

Thereafter, inventors created a workstation that attaches to an existing desk ledge with the use of clamps and other attaching devises, (As in U.S. Pat. No. 6,158,359), which becomes ineffective after extended periods of computer use. There is still an undue strain placed on the user's back, shoulder and eyes, (due to the position of the “extension” off of the existing desk.).

Several types of detached workstations have been proposed—for example in U.S. Pat. No. 5,735,222,. Although intriguing to the eye, they do not support the proper alignment and position need for user comfort.

a) There manufacture does not allow for the user to adjust the tilt and angle for optimum comfort to the individual user. There is no flexibility to the user in regards to mobility. Since the pole extensions or leg supports must be placed between or around the legs of the user, thus movement is restricted.

b) If one uses a permanently attached workstation, there is a concern for the left handed user, which would need to use the mouse on their left side (their natural master of motor skills.)

c) There has also been a proposal utilizing a tray designed with extruded walls (See U.S. Pat. No. D427,165). This is not made for the best posture or comfort of the user since this tray must be used with in the confines of the users desk; there is no advantage to the user due to the lack of adjustability. No tilt or positional adjustments can be made for individual comfort.

### SUMMARY

In accordance with the present invention, a portable keyboard and mouse workstation comprised of a solid piece of wood with recessed areas to accommodate a keyboard and mouse. An attached filled bag on the underside of the board provides the stability and adjustability that is needed for individual comfort. The disadvantages of wrist and shoulder strain demonstrated in the above section are eliminated by allowing the user to place the keyboard and mouse on their lap. By positioning the filled bag, the user can adjust the tilt and position of the keyboard and mouse to reduced shoulder, wrist and posture strain.

Besides the objects and advantages of the portable keyboard and mouse workstation described in my above patent, several objects and advantages of the present patent are to:

1. Provide a stable workstation to be used on a flat surface, (i.e.: desktop), and still offer the advantage of obtaining a comfortable angle to help reduce wrist stress and strain.

2. Provide a stable workstation for laptop computers.

3. Provide the proper workstation for left handed users by situating the mouse area to the left of the user. Until now there are no portable left-handed workstations that offer this advantage.

4. Provide a workstation for infra-red keyboard users that is truly portable and can be used in any comfortable position whether on floor, couch, bed, or chair.

5. Provide a portable workstation that individuals of any age or size can use

6. Provide a workstation that will match any room décor by offering a variety of wood tones and fabric choices to meet the individuals' tastes and desires.

7. Provide a portable workstation that can be treated as a piece of fine furniture and become part of the computer room fixtures without looking out of place.

8. Provide a portable workstation that can easily be put away without having to remove cumbersome clamps, cables, tripods, and other connecting devices that must be mounted to the desktop.

9. Provide a portable workstation that helps reduce the unnecessary strain on the individual's shoulder by having to reach for the mouse while working at the computer.

10. Provide a portable workstation that reduces back strain by improving ones posture while sitting in front of the computer, by letting the individual sit in a more upright position with his/her back straight and securely in their chair.

11. Provide a portable workstation that lets the user sit further back from the computer monitor thus helping to eliminate unnecessary eyestrain caused by sitting too close to the monitor screens.

### BRIEF DESCRIPTION OF THE DRAWINGS

FIGS. 1A to 1B show various aspects of the cloth bag supplied with the liner and fill. FIGS. 2A to 2B show various aspects of the Portable PC keyboard and mouse tray showing the recessed areas to accept the users keyboard and mouse and the attached filled cloth bag.

Reference Numerals:

| | |
|---|---|
| 1. Recessed Keyboard Area | 2. Recessed Mouse Area |
| 3. Cloth Border | 4. Portable PC keyboard and mouse tray |
| 5. Dividing wall | 6. Filled Cloth Bag |
| 7. Outer Shell Material | 8. Liner |
| 9. Fill | |

### PREFERRED EMBODIMENT

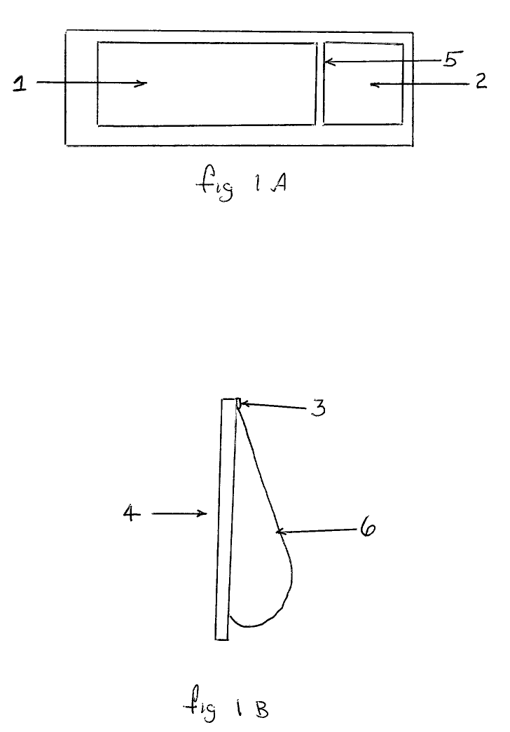

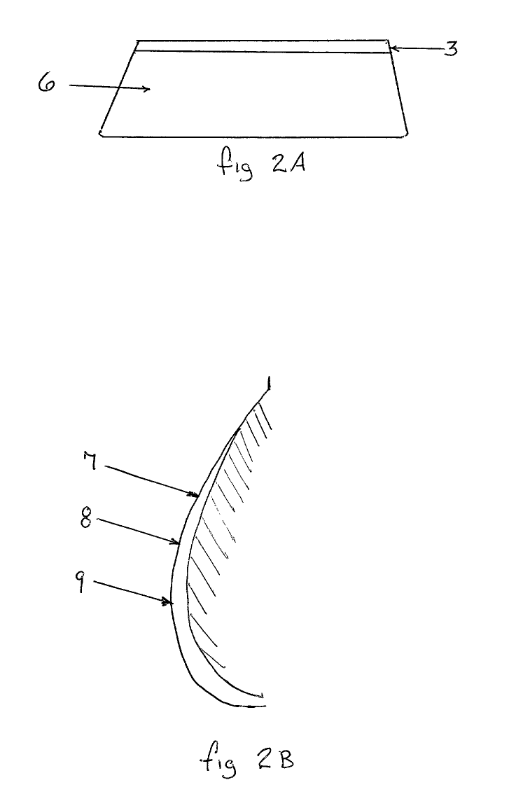

A preferred embodiment of the Portable PC keyboard and mouse tray of the present invention is illustrated in FIGS. 1A and 1B. The Portable PC keyboard and mouse tray has a recessed Keyboard Area 1 and a recessed mouse area 2 separated by a dividing wall 5. The filled cloth bag 6 is attached to the back of the Portable PC keyboard and mouse tray board 4 and a strip of cloth boarder 3 is added. FIG. 2A illustrates the Filled Cloth Bag 6 and the Cloth Boarder 3. FIG. 2B illustrates the construction of the Filled cloth bag by showing the Outer Shell Material 7, the Liner 8 and the Fill 9.

### DETAILED DESCRIPTION

The first portable form fitting keyboard tray. Laptop tray is made of wood compartments routed out to hold the keyboard and mouse pad. A filled cloth bag is attached to the underside for comfort and stability. The bag is filled with polystyrene balls and or batten, and or foam fill.

The portable PC keyboard and mouse tray is made from a 1″×6″×¾″ pine. It has a 32″×11″ form filled bag attached to the bottom. The overall finished dimensions of the board are 32″ long by 11¼″ wide by ¾″ thick. The board has two areas routed out. A keyboard area that is 19¼″ long and 8½″ wide and ½″ deep and a mouse pad area that is 8½′ wide by 8½″ long and ¼″ deep. A ⅝″ wall separates them.

Outer edges of the board are rounded by using a router and a ½″ rounder over bit. The board is sanded smooth and stained. Two coats of polyurethane are applied. This is now the finished tray.

The bag is made of cloth material that is filled with polystyrene and or batten and or foam fill. The bag is attached to the underside of the back edge of the tray. A strip of cloth boarder is applied.

The tray Portable PC Keyboard and Mouse Tray is now ready for use.

1. We claim our invention of the Portable PC keyboard and mouse tray to be a portable workstation for the laptop or keyboard and mouse fitted with an attached filled bag thus allowing for the adjustment of distance between the user and monitor, adjustment of the tilt of the laptop or keyboard for comfort and reduced strain of the wrist, placement of mouse to reduce shoulder and back strain while allowing flexibility and mobility of the user.

2. We claim to provide a stable workstation to be used on a flat surface, (i.e.: desktop), and still offer the advantage of obtaining a comfortable angle to help reduce wrist stress and strain if the individual prefers being closer to the computer monitor.

3. We claim to provide a stable workstation for laptop computers.

4. We claim to provide the proper workstation for left handed users by situating the mouse area to the left of the user. Until now there are no portable left-handed workstations that offer this advantage.

5. We claim to provide a workstation for infra-red keyboard users that is truly portable and can be used in any comfortable position whether on floor, couch, bed, or chair.

6. We claim to provide a portable workstation that individuals of any age or size can use

7. We claim to provide a workstation that will match any room décor by offering a variety of wood tones and fabric choices to meet the individuals' tastes and desires.

8. We claim to provide a portable workstation that can be treated as a piece of fine furniture and become part of the computer room fixtures without looking out of place.

9. We claim to provide a portable workstation that can easily be put away without having to remove cumbersome clamps, cables, tripods, and other connecting devices that must be mounted to the desktop.

10. We claim to provide a portable workstation that helps reduce the unnecessary strain on the individual's shoulder by having to reach for the mouse while working at the computer.

11. We claim to provide a portable workstation that reduces back strain by improving ones posture while sitting in front of the computer, by letting the individual sit in a more upright position with their back straight and securely in their chair.

12. We claim to provide a portable workstation that lets the user sit further back from the computer monitor thus helping to eliminate unnecessary eyestrain caused by sitting too close to the monitor screens.

13. We claim to provide a portable workstation that lets the user sit further back from the computer monitor thus helping to reduce exposure to any harmful radiation that may be emitted by the monitor.
